(19) United States
(12) Patent Application Publication
(10) Pub. No.: US 2014/0151030 A1
(43) Pub. Date: Jun. 5, 2014

(54) Method of Inserting a Fiber Optic Cable into Coiled Tubing

(71) Applicants: Dale E. Jamison, Houston, TX (US); Chris Andrew Marvel, Houston, TX (US)

(72) Inventors: Dale E. Jamison, Houston, TX (US); Chris Andrew Marvel, Houston, TX (US)

(73) Assignee: Halliburton Energy Services, Inc., Houston, TX (US)

(21) Appl. No.: 13/690,796

(22) Filed: Nov. 30, 2012

(51) Int. Cl. E21B 47/01; H02G 9/06; E21B 17/20

(52) U.S. Cl. CPC E21B 47/01; E21B 17/206; H02G 9/06
USPC 166/250.01; 166/380; 254/134.3 R

(57) ABSTRACT

Methods and apparatuses used with coiled tubing are disclosed. A method of inserting a fiber optic cable into coiled tubing is provided. The method comprises providing a coiled tubing having a first opening at a first end of the coiled tubing and a second opening at a second end of the coiled tubing. The fiber optic cable is fed into the first opening of the coiled tubing so that the fiber optic cable advances inside the coiled tubing along a direction from the first end to the second end. The fiber optic cable is vibrated during the feeding of the fiber optic cable into the coiled tubing.

### BACKGROUND

The present invention relates to methods and apparatuses used with coiled tubing. More particularly, the present invention relates to a method of inserting a fiber optic cable into coiled tubing.

Coiled tubing can currently have a length up to about 24,000 feet and is coiled on a 10-12 foot diameter spool. The coiled tubing is typically made of steel and has an interior diameter of 1¾ to 2 inches, whereas fiber optic cable typically has a diameter of ⅛ to ¼ inches. The fiber optic cable is generally sheathed in stainless steel or inconel to protect the fiber optic from breaking or chemical attack. The fiber optic cable can get stuck due to friction between the cable and the coiled tubing when being inserted into coiled tubing.

### SUMMARY OF THE INVENTION

The present invention relates to methods and apparatuses used with coiled tubing. More particularly, the present invention relates to a method of inserting a fiber optic cable into coiled tubing.

In some embodiments, the present invention provides a method of inserting a fiber optic cable into coiled tubing comprising providing a coiled tubing having a first opening at a first end of the coiled tubing and a second opening at a second end of the coiled tubing. The fiber optic cable is fed into the first opening of the coiled tubing so that the fiber optic cable advances inside the coiled tubing along a direction from the first end to the second end. The fiber optic cable is vibrated during the feeding of the fiber optic cable into the coiled tubing.

In other embodiments, the present invention provides a method of monitoring an environmental condition inside a wellbore comprising providing a coiled tubing used for operations in the wellbore having a first opening at a first end of the coiled tubing and a second opening at a second end of the coiled tubing. A fiber optic cable is fed into the first opening of the coiled tubing so that the fiber optic cable advances inside the coiled tubing along a direction from the first end to the second end. The fiber optic cable is vibrated while feeding the fiber optic cable. The coiled tubing comprising the fiber optic cable is inserted into the wellbore, and the environmental condition is monitored via signals transmitted along the fiber optic cable.

In other embodiments, the present invention provides a method of monitoring parameters of a bottom-hole assembly inside a wellbore comprising providing a coiled tubing used for operations in an oil or gas well having a first opening at a first end of the coiled tubing and a second opening at a second end of the coiled tubing. The fiber optic cable is fed into the first opening of the coiled tubing so that the fiber optic cable advances inside the coiled tubing along a direction from the first end to the second end. The fiber optic cable is vibrated while feeding the fiber optic cable. The coiled tubing comprising the fiber optic cable is inserted into the wellbore. The parameter of the bottom-hole assembly is monitored via signals transmitted along the fiber optic cable.

In still other embodiments, the present invention provides an apparatus for inserting a fiber optic cable into a coiled tubing used for operations in an oil or gas well comprising a cable feeding mechanism configured to feed the fiber optic cable into the coiled tubing so that the fiber optic cable is inserted into a first opening at a first end of the coiled tubing and is advanced in a direction from the first end to a second end of the coiled tubing. The cable feeding mechanism is configured to vibrate the fiber optic cable while feeding the fiber optic cable. The apparatus further comprises a controller configured to: monitor a rate of feeding the fiber optic cable into the coiled tubing, monitor vibration parameters, and control the rate of feeding the fiber optic cable into the coiled tubing.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a plan view of fiber optic cable being fed into coiled tubing according to an embodiment of the present disclosure.

FIG. 2 is a side view of fiber optic cable being fed into coiled tubing according to an embodiment of the present disclosure.

FIG. 3 illustrates the steps of a method of inserting a fiber optic cable into coiled tubing according to an embodiment of the present disclosure.

FIG. 4 is a plan view of fiber optic tubing cable being fed into coiled tubing according to an embodiment of the present disclosure.

FIG. 5 illustrates a profile of translational motion of fiber optic cable during feeding into the coiled tubing according to an embodiment of the present disclosure.

FIG. 6 illustrates a profile of frequency of reciprocating motion applied to the fiber optic cable during feeding into the coiled tubing according to an embodiment of the present disclosure.

FIG. 7 illustrates a profile of rotational motion applied to the fiber optic cable during feeding into the coiled tubing according to an embodiment of the present disclosure.

FIG. 8 illustrates the steps of a method of monitoring an environmental condition inside a wellbore according to an embodiment of the present disclosure.

FIG. 9 illustrates the steps of a method of monitoring parameters of a bottom-hole assembly inside a wellbore according to an embodiment of the present disclosure.

### DETAILED DESCRIPTION

The present invention relates to methods used with coiled tubing. More particularly, the present invention relates to a method of inserting a fiber optic cable into coiled tubing.

A method is provided which reduces friction when forcing fiber optic cable into coiled tubing by creating vibrations in the fiber optic cable, thereby causing intermittent contact between the fiber optic cable and the coiled tubing. This intermittent contact reduces the overall amount of contact of the fiber optic cable and the internal wall of the coiled tubing, thus facilitating the initiation or continuation of forward motion. The coiled tubing can be used for operations in an oil or gas well, and the fiber optic cable can be a sheathed fiber optic able.

According to embodiments of the disclosed methods, continuous or intermittent vibrations in the fiber optic cable can be achieved in one or more directions. The vibration may be along the axis of the cable, normal to the axis of the cable, rotational about the axis of the cable or a combination of one or more of these directions. The vibrations can be produced in the cable by a mechanical device that imposes a fixed vibration at a fixed amplitude and frequency in a fixed direction, such as by a flywheel with an offset connecting rod or a vibrating wire feeder used to transmit the oscillating energy to the cable.

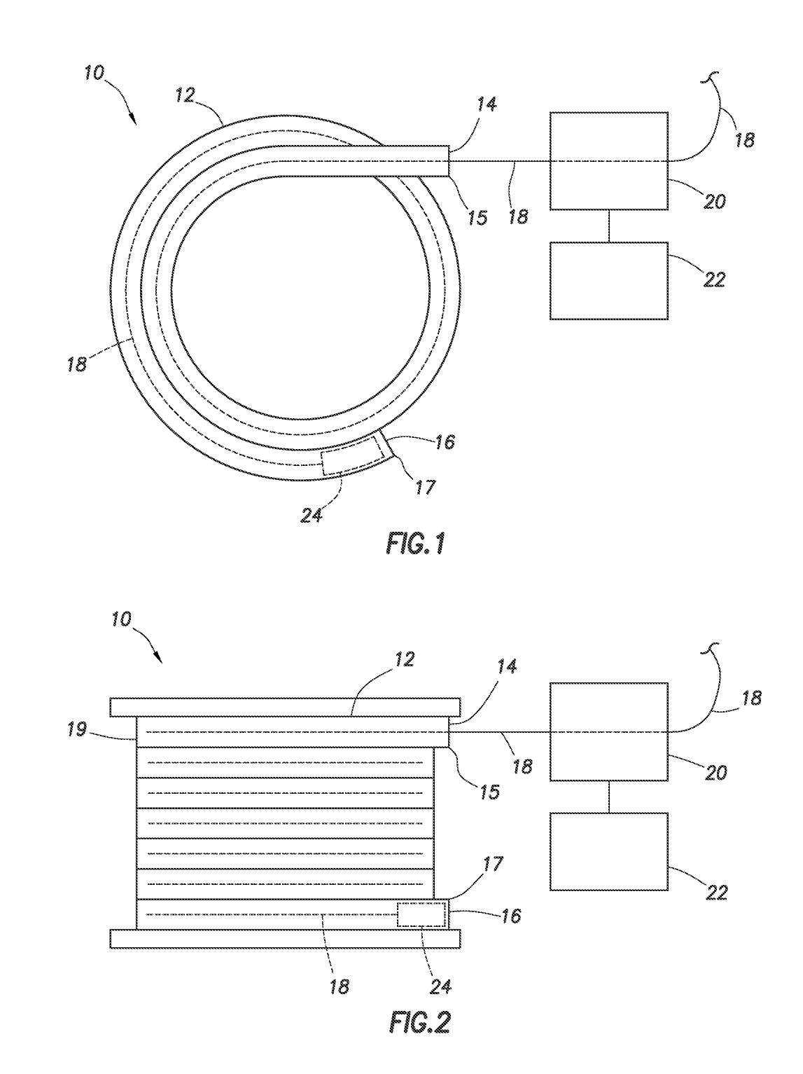

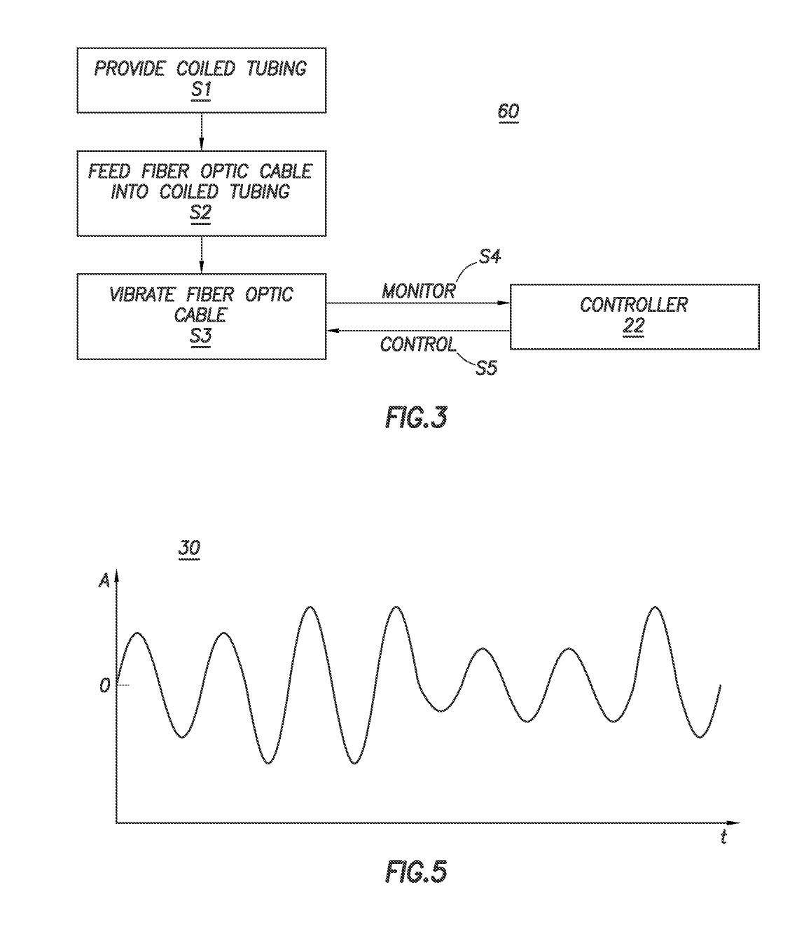

As illustrated in FIGS. 1, 2, and 3, an embodiment of the present disclosure is a method 60 of inserting a fiber optic cable 18 into coiled tubing 12 comprising providing a coiled tubing 12 having a first opening 14 at a first end 15 of the coiled tubing 12 and a second opening 16 at a second end 17 of the coiled tubing 12, as at S1. The fiber optic cable 18 may be fed into the first opening 14 of the coiled tubing 12 so that the fiber optic cable 18 advances inside the coiled tubing 12 along a direction from the first end 15 to the second end 17, as at S2. In some embodiments, the fiber optic cable 18 may be vibrated during the feeding of the fiber optic cable 18 into the coiled tubing 12, as at S3.

In certain embodiments of the disclosure, only the fiber optic cable 18 is vibrated. The coil tubing 12 is essentially stationary while the fiber optic cable 18 is being fed.

In certain embodiments of the disclosure, the coiled tubing 12 comprises a plurality of windings 19.

In certain embodiments of the present disclosure, vibrating the fiber optic cable 18 may include imposing at least one motion on the fiber optic cable while the fiber optic cable 18 is being fed into the coiled tubing 12, the at least one motion being selected from the group consisting of a reciprocating motion applied to the fiber optic cable 18 along a direction the fiber optic cable 18 is being fed into the coiled tubing 12, a rotational motion applied to the fiber optic cable 18 about an axis along the direction the fiber optic cable 18 is being fed into the coiled tubing 12, and a translational motion applied to the fiber optic cable 18 perpendicular to the axis along the direction the fiber optic cable 18 is being fed into the coiled tubing 12.

In certain embodiments of the disclosure, the method 60 may further include monitoring a feed rate of the fiber optic cable 18 while vibrating the fiber optic cable 18, as at S4.

In certain embodiments of the disclosure, an angle of the rotational motion, an amplitude of the reciprocating motion, an amplitude of the translational motion, a frequency of the rotational motion, a frequency of the reciprocating motion, a frequency of the translational motion, or combinations thereof, may be varied while vibrating the fiber optic cable 18.

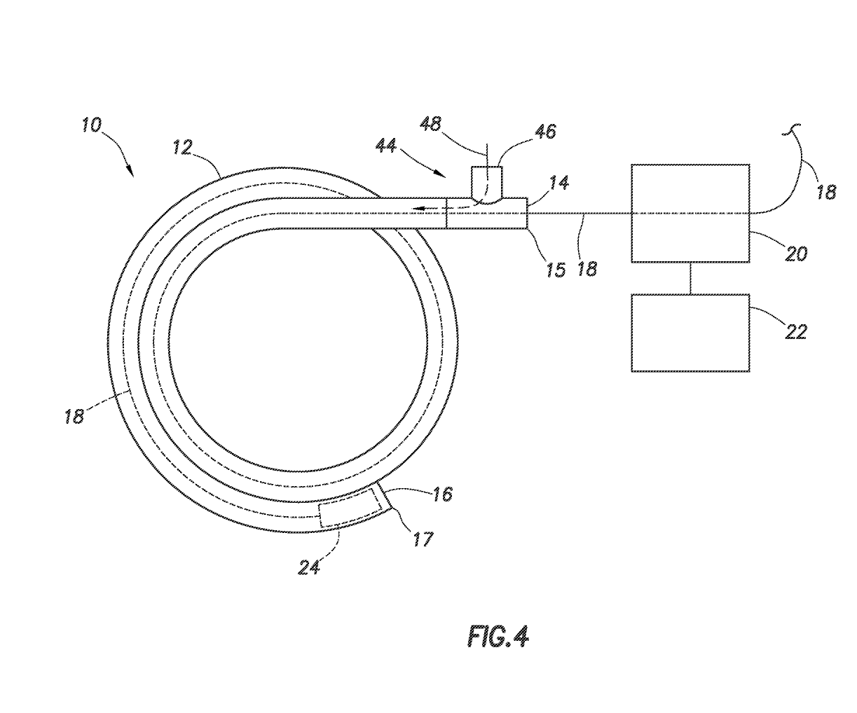

Referring now to FIG. 4, in certain embodiments of the disclosure, a fluid 48 may be pumped into the coiled tubing 12 in conjunction with the vibration during the insertion of the fiber optic cable 18 from the first end 15 to the second end 17. In this method a narrow region at the beginning of the cable 18 causes the pumped fluid 48 to pull on the cable 18. In this configuration the cable 18 may lock up as in a capstan arrangement. The vibration may serve to unlock or otherwise prevent the capstan effect on the cable 18 allowing it to be pulled through the coiled tubing 12 with pumping pressure. As shown in FIG. 4, a fluid 48 may be pumped through a fluid entry opening 46 of an end portion 44 of the coiled tubing 12. In certain embodiments, the pump rate of the fluid 48 can be varied while the fiber optic cable 18 is being fed into the coiled tubing 12.

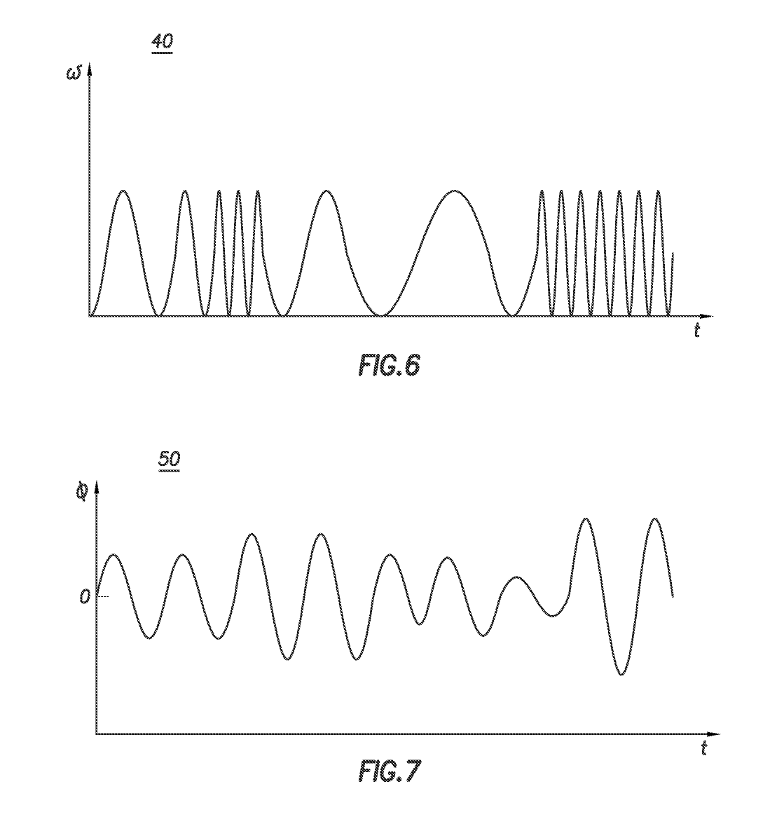

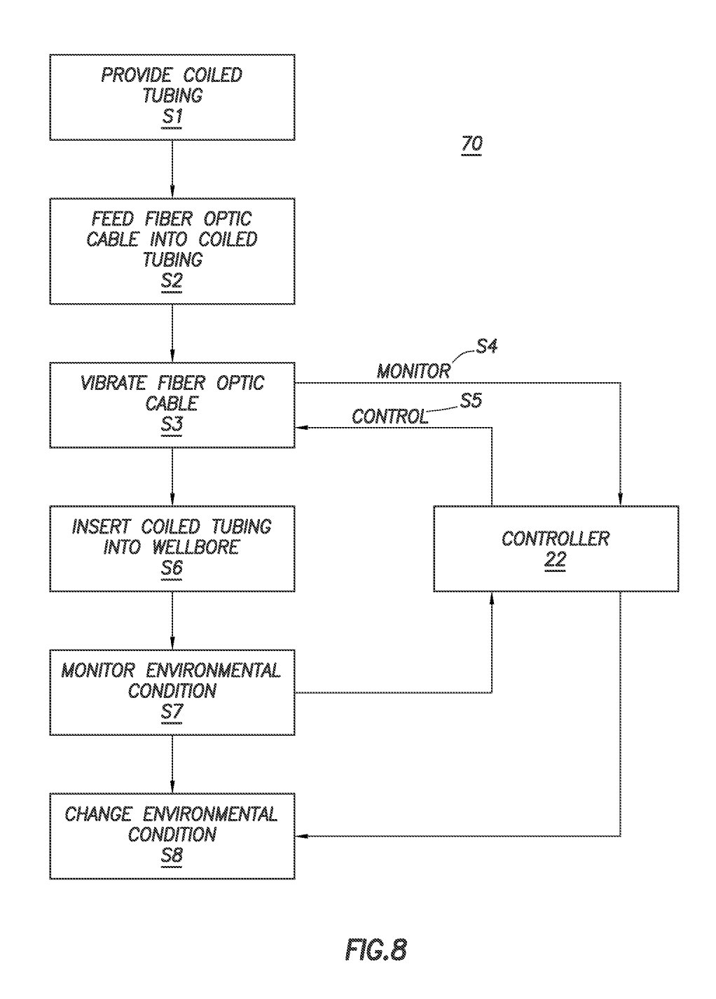

In certain embodiments, the amplitude of the translational motion can be varied with time as illustrated in the profile of translational motion of the fiber optic cable during feeding into the coiled tubing 30 in FIG. 5. In certain embodiments, the frequency of vibration can be varied with time as illustrated in the profile of frequency of reciprocating motion applied to the fiber optic cable during feeding into the coiled tubing 40 in FIG. 6. In certain embodiments, the fiber optic cable can be variably rotated about its axis as illustrated in the profile of frequency of rotational motion applied to the fiber optic cable during feeding into the coiled tubing 50 in FIG. 7.

Referring again to FIG. 3, in certain other embodiments of the present disclosure, the angle, the amplitude, or the frequency of motion, and combinations thereof, are controlled while vibrating fiber optic cable, thereby controlling a feed rate of the fiber optic cable 18, as at S1. Controlling the angle, the amplitude, or the frequency of motion, may include applying a range of angles, amplitudes, or frequencies of motion, and combinations thereof according to embodiments of the present disclosure. In certain embodiments, the angle, the amplitude, and the frequency of motion while vibrating the fiber optic cable may be tunable, thereby controlling harmonics of fiber optic cable 18 motion as a length of the fiber optic cable 18 inserted in the coiled tubing 12 changes.

During the step of vibrating S3, the fiber optic cable 18 may be passed through substantially an entire length of the coiled tubing 12 from the first end 15 to the second end 17 in certain embodiments.

In certain embodiments of the present disclosure, a high frequency and small displacement oscillation can be applied to the fiber optic cable 18. In such an instance, the high energy may minimize friction, thus allowing the fiber optic cable 18 to advance in the coiled tubing 12, while the small displacement may prevent any damage to the fiber optic cable 18.

Referring now to FIG. 8, with continued reference to FIGS. 1, 2, and 4, illustrated is a method of monitoring an environmental condition inside a wellbore 70, the method 70 may include providing a coiled tubing 12 used for operations in the wellbore having a first opening 14 at a first end 15 of the coiled tubing 12 and a second opening 16 at a second end 17 of the coiled tubing 12, as at S1. A fiber optic cable 18 may be fed into the first opening 14 of the coiled tubing 12 so that the fiber optic cable 18 advances inside the coiled tubing 12 along a direction from the first end 15 to the second end 17, as at S2. The fiber optic cable 18 may be vibrated while feeding the fiber optic cable 18, as at S3. The coiled tubing 12 comprising the fiber optic cable 18 may subsequently be inserted into the wellbore, as at S6. The environmental condition may be monitored via signals transmitted along the fiber optic cable 18, as at S7. In certain embodiments, an operation in the wellbore is changed in response to the environmental condition sensed while monitoring the environmental condition, as at S8.

In certain embodiments, the environmental condition may be sensed by a distributed acoustic sensor.

In certain embodiments of the disclosure, the fiber optic cable 18 may be vibrated by imposing at least one motion on the fiber optic cable 18 while it is being fed into the coiled tubing 12, the at least one motion being selected from the group consisting of a reciprocating motion applied to the fiber optic cable 18 along a direction the fiber optic cable 18 is being fed into the coiled tubing 12, a rotational motion applied to the fiber optic cable 18 about an axis along the direction the fiber optic cable 18 is being fed into the coiled tubing 12, and a translational motion applied to the fiber optic cable 18 perpendicular to the axis along the direction the fiber optic cable 18 is being fed into the coiled tubing 12. In certain embodiments, an angle of the rotational motion, an amplitude of the reciprocating motion, an amplitude of the translational motion, a frequency of the rotational motion, a frequency of the reciprocating motion, a frequency of the translational motion, or combinations thereof may be varied while vibrating the fiber optic cable 18.

In certain embodiments of the disclosure, the environmental condition monitored is selected from the group consisting of temperature, pressure, fluid flow, fluid composition, mud composition, well depth, or combinations thereof.

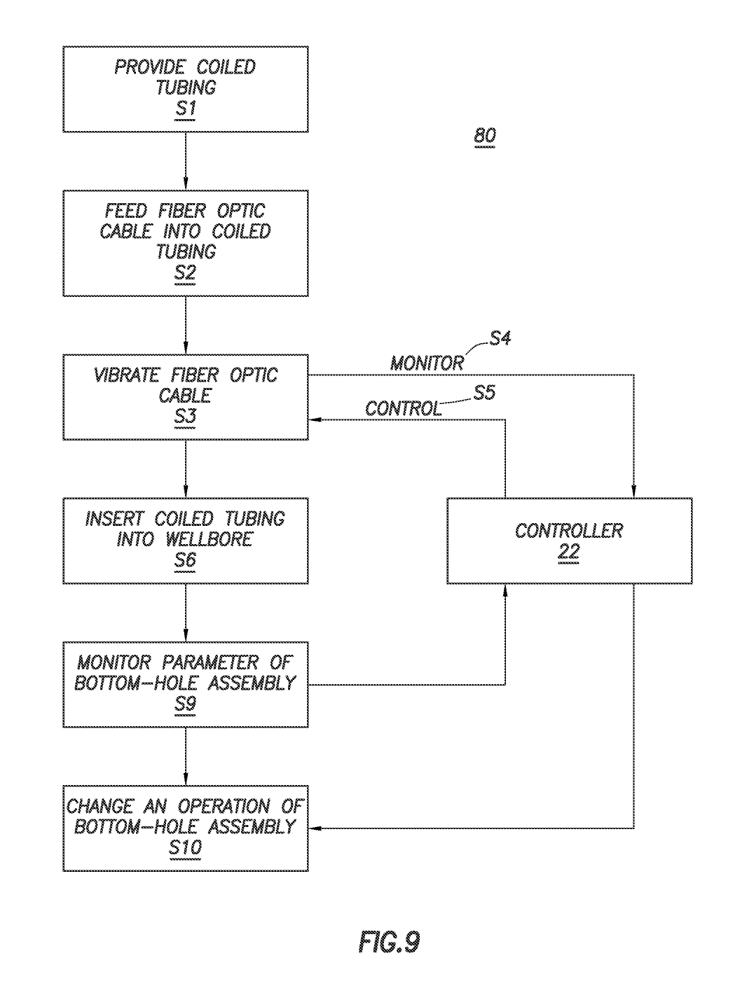

Referring now to FIG. 9, with continued reference to FIGS. 1, 2, and 4, illustrated is a method of monitoring parameters of a bottom-hole assembly 24 inside a wellbore 80. The method 80 may include providing a coiled tubing 12 used for operations in an oil or gas well having a first opening 14 at a first end 15 of the coiled tubing 12 and a second opening 16 at a second end 17 of the coiled tubing 12, as at S1. A fiber optic cable 18 may be fed into the first opening 14 of the coiled tubing 12 so that the fiber optic cable 18 advances inside the coiled tubing 12 along a direction from the first end 15 to the second end 17, as at S2. The fiber optic cable 18 may be vibrated while feeding S2 the fiber optic cable 18, as at S3. The coiled tubing 12 comprising the fiber optic cable 18 may subsequently be inserted into the wellbore, as at S6, and the parameter of the bottom-hole assembly may be monitored via signals transmitted along the fiber optic cable 18, as at S9. In certain embodiments, an operation of the bottom-hole assembly 24 may be changed in response to the parameter sensed while monitoring the bottom-hole assembly 24, as at S10.

In certain embodiments, monitoring the parameter of the bottom-hole assembly 24, as at S9, may be performed during acidizing, fracturing, gravel packing, or a completion operation.

In certain embodiments, the parameters being monitored are selected from the group consisting of temperature, location, and motion of the bottom-hole assembly 24. In other embodiments, the temperature and/or force on a drill bit may be monitored. In other further embodiments, the distributed temperature and/or distributed pressure along the length of the wellbore may be monitored.

Referring again to FIGS. 1, 2, and 4, and in certain embodiments of the disclosure, an apparatus 10 for inserting a fiber optic cable 18 into a coiled tubing 12 used for operations in an oil or gas well may include a cable feeding mechanism 20 configured to feed the fiber optic cable 18 into the coiled tubing 12 so that the fiber optic cable 18 is inserted into a first opening 14 at a first end 15 of the coiled tubing 12 and is advanced in a direction from the first end 15 to a second end 17 of the coiled tubing 12. The fiber optic cable feeding mechanism 20 may be configured to vibrate the fiber optic cable 18 while feeding the fiber optic cable 18. In addition, a controller 22 may be communicably coupled to the fiber optic cable feeding mechanism 20 and configured to monitor a rate of feeding the fiber optic cable 18 into the coiled tubing 12, monitor vibration parameters, and control the rate of feeding the fiber optic cable 18 into the coiled tubing 12.

In certain embodiments, the controller 22 may be configured to control the rate of feeding the fiber optic cable 18 into the coiled tubing 12 by controlling at least one motion of the fiber optic cable 18 while it is being fed into the coiled tubing 12, the at least one motion being selected from the group consisting of a reciprocating motion of the fiber optic cable 18 along a direction the fiber optic cable 18 is being fed into the coiled tubing 12, a rotational motion of the fiber optic cable 18 about an axis along the direction the fiber optic cable 18 is being fed into the coiled tubing 12, and a translational motion of the fiber optic cable 18 perpendicular to the axis along the direction the fiber optic cable 18 is being fed into the coiled tubing 12.

In certain embodiments of the present disclosure, the controller 22 may be configured to vary at least one of an angle of the rotational motion, an amplitude of the reciprocating motion, an amplitude of the translational motion, a frequency of the rotational motion, a frequency of the reciprocating motion, a frequency of the translational motion, or combinations thereof. In certain embodiments, the controller 22 may be configured to apply a range of the angles, amplitudes, or frequencies, and combinations thereof. The controller 22 may be configured to tune the angle, the amplitude, or the frequency of motion, to thereby control harmonics of cable motion as a length of the fiber optic cable 18 inserted in the coiled tubing 12 changes. The controller 22 may be able to optimize the vibration to produce the most useful effect for the particular conditions under which the apparatus 10 is operating in certain embodiments. Furthermore, the controller 22 may be able to record the effectiveness of various vibrations and the conditions under which they were used. Thus, the controller 22 may be able to continuously vary the vibration parameters (e.g., rotation, translation, and frequency) based on the effectiveness of the of the vibration parameters imposed.

In certain embodiments of the disclosure, the controller 22 can be a programmable controller, such as a computer. The controller 22 can be programmed to monitor environmental conditions inside a wellbore. The controller 22 can also be programmed to change an operation in the wellbore in response to the environmental condition sensed. In certain embodiments of the disclosure, the controller 22 can be programmed to monitor a parameter of a bottom-hole assembly 24 and to change an operation of the bottom-hole assembly 24 in response to the parameter sensed.

The methods and apparatuses of the disclosure can augment and/or replace the conventional approach of pumping cable into a section of coiled tubing, thereby allowing cable to be inserted into longer lengths of coiled tubing.

The method of the disclosure may also be applicable to removing fiber optic cables 18 from coiled tubing 12.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1.-13. (canceled)

14. A method of monitoring an environmental condition inside a wellbore comprising:
providing a coiled tubing used for operations in the wellbore, the coiled tubing having a first opening at a first end of the coiled tubing and a second opening at a second end of the coiled tubing;
feeding a fiber optic cable into the first opening of the coiled tubing so that the fiber optic cable advances inside the coiled tubing along a direction from the first end to the second end;
vibrating the fiber optic cable while feeding the fiber optic cable;
inserting the coiled tubing comprising the fiber optic cable into the wellbore; and
monitoring the environmental condition via signals transmitted along the fiber optic cable.

15. The method according to claim 14, further comprising changing an operation in the wellbore in response to the environmental condition sensed during the monitoring the environmental condition.

16. The method according to claim 15, wherein the environmental condition is sensed by a distributed acoustic sensor.

17. The method according to claim 14, wherein the fiber optic cable is vibrated by imposing at least one motion on the fiber optic cable while it is being fed into the coiled tubing, the at least one motion being selected from the group consisting of a reciprocating motion applied to the fiber optic cable along a direction the fiber optic cable is being fed into the coiled tubing, a rotational motion applied to the fiber optic cable about an axis along the direction the fiber optic cable is being fed into the coiled tubing, and a translational motion applied to the fiber optic cable perpendicular to the axis along the direction the fiber optic cable is being fed into the coiled tubing.

18. The method according to claim 17, wherein an angle of the rotational motion, an amplitude of the reciprocating motion, an amplitude of the translational motion, a frequency of the rotational motion, a frequency of the reciprocating motion, a frequency of the translational motion, or combinations thereof are varied during said vibrating the fiber optic cable.

19. The method according to claim 14, wherein the environmental condition monitored is selected from the group consisting of temperature, pressure, fluid flow, fluid composition, mud composition, well depth, or combinations thereof.

20. A method of monitoring a parameter of a bottom-hole assembly inside a wellbore comprising:
providing a coiled tubing used for operations in an oil or gas well, the coiled tubing having a first opening at a first end of the coiled tubing and a second opening at a second end of the coiled tubing;
feeding a fiber optic cable into the first opening of the coiled tubing so that the fiber optic cable advances inside the coiled tubing along a direction from the first end to the second end;
vibrating the fiber optic cable while feeding the fiber optic cable;
inserting the coiled tubing comprising the fiber optic cable into the wellbore; and
monitoring the parameter of the bottom-hole assembly via signals transmitted along the fiber optic cable.

21. The method according to claim 20, further comprising changing an operation of the bottom-hole assembly in response to the parameter sensed during the monitoring the bottom-hole assembly.

22. The method according to claim 20, wherein the monitoring the parameter of the bottom-hole assembly is performed during acidizing, fracturing, gravel packing, or a completion operation.

23. The method according to claim 20, wherein the fiber optic cable is vibrated by imposing at least one motion on the fiber optic cable while it is being fed into the coiled tubing, the at least one motion being selected from the group consisting of a reciprocating motion applied to the fiber optic cable along a direction the fiber optic cable is being fed into the coiled tubing, a rotational motion applied to the coiled tubing about an axis along the direction the coiled tubing is being fed into the coiled tubing, and a translational motion applied to the fiber optic cable perpendicular to the axis along the direction the fiber optic cable is being fed into the coiled tubing.

24. The method according to claim 23, wherein an angle of the rotational motion, an amplitude of the reciprocating motion, an amplitude of the translational motion, a frequency of the rotational motion, a frequency of the reciprocating motion, a frequency of the translational motion, or combinations thereof are varied during said vibrating the fiber optic cable.

25. The method according to claim 20, wherein the parameter being monitored is selected from the group consisting of temperature, location, and motion of the bottom-hole assembly.

26. An apparatus for inserting a fiber optic cable into a coiled tubing used for operations in an oil or gas well comprising:
a cable feeding mechanism configured to feed the fiber optic cable into the coiled tubing so that the fiber optic cable is inserted into a first opening at a first end of the coiled tubing and is advanced in a direction from the first end to a second end of the coiled tubing, wherein the cable feeding mechanism is configured to vibrate the fiber optic cable while feeding the fiber optic cable; and
a controller configured to:
monitor a rate of feeding the fiber optic cable into the coiled tubing;
monitor vibration parameters; and
control the rate of feeding the fiber optic cable into the coiled tubing.

27. The apparatus according to claim 26, wherein the controller is configured to control the rate of feeding the fiber optic cable into the coiled tubing by controlling at least one motion of the fiber optic cable while it is being fed into the coiled tubing, the at least one motion being selected from the group consisting of a reciprocating motion of the fiber optic cable along a direction the fiber optic cable is being fed into the coiled tubing, a rotational motion of the fiber optic cable about an axis along the direction the fiber optic cable is being fed into the coiled tubing, and a translational motion of the fiber optic cable perpendicular to the axis along the direction the fiber optic cable is being fed into the coiled tubing.

28. The apparatus according to claim 27, wherein the controller is configured to vary at least one of an angle of the rotational motion, an amplitude of the reciprocating motion, an amplitude of the translational motion, a frequency of the rotational motion, a frequency of the reciprocating motion, a frequency of the translational motion, or combinations thereof.

29. The apparatus according to claim 28, wherein the controller is configured to apply a range of the angles, amplitudes, or frequencies, and combinations thereof.

30. The apparatus according to claim 28, wherein controller is configured to tune the angle, the amplitude, or the frequency of motion, to thereby control harmonics of cable motion as a length of the fiber optic cable inserted in the coiled tubing changes.
